(19) United States
(12) Patent Application Publication
(10) Pub. No.: US 2014/0102068 A1
(43) Pub. Date: Apr. 17, 2014

(54) SPEED CONTROL DEVICE FOR LAWNMOWER

(71) Applicant: HONDA MOTOR CO., LTD., Tokyo (JP)

(72) Inventor: Shengyong Zhang, Reidsville, NC (US)

(73) Assignee: HONDA MOTOR CO., LTD., Tokyo (JP)

(21) Appl. No.: 13/650,915

(22) Filed: Oct. 12, 2012

(51) Int. Cl. A01D 34/00

(52) U.S. Cl. 56/16.7

(57) ABSTRACT

A variable speed, self-propelled walk-behind lawnmower includes a housing, a blade housed within the housing for cutting and a handle extending rearwardly from the housing. The handle includes a slidably mounted speed control member movable for adjusting a speed at which a transmission mounted on the housing drives a wheel rotatably mounted to the housing with motive of power from an engine mounted on the housing.

### BACKGROUND

Self-propelled machines, such as lawn mowing machines and the like, often provide handles on which controls are mounted for engagement and/or manipulation by operators or users of such machines. In particular, a “walk behind” type, self-propelled mowing machine typically has a handle extending obliquely behind a power plant or other main operative assembly of the machine for gripping by an operator as the operator walks behind the machine during movement thereof in a forward direction. Often, one or more controls are mounted on the handle for the user to manipulate while gripping the handle and operating the machine. Most known controls require the operator to control two or more separate functions (e.g., operator presence control and speed control) while simultaneously manipulating the machine (e.g., steering the machine).

One known control is the operator presence control or “dead man” control, which generally includes a spring-biased handle which can be grasped by the operator during normal operation of the machine to enable the motor of the machine. If the operator presence control handle is released, the machine action is rapidly terminated for reasons of safety. Another such control is the speed control, which for self-propelled mowing machines is generally connected to a variable speed transmission associated with the engine and controls the speed of the self-propelled traction wheels. Known speed controls typically comprise a lever pivotally mounted on the machine handle such that the speed of the self-propulsion can be controlled by moving the lever back and forth. This often requires the operator to remove one hand from the handle in order to operate the speed control. Another known speed control provides an twist actuator that is rotatably provided on the machine handle. Generally, this twist control requires the user to perform a twisting action with his or her thumbs.

### SUMMARY

According to one aspect, a lawnmower includes an open-bottomed housing for rotatably housing a blade for cutting grass and a prime mover mounted on the housing for rotatably driving the blade. At least one wheel is rotatably mounted to the housing and operatively connected through a transmission to the prime mover for driving thereof, wherein the transmission controls the speed at which the prime mover rotates the at least one wheel. The lawnmower further includes an operating handle extending rearwardly from the housing and a speed control device. The operating handle includes at least one leg extending from the housing and a grasping portion supported by the at least one leg in spaced relation relative to the housing. The speed control device includes a speed control member slidably mounted on the grasping portion and operatively connected to the transmission for adjusting the speed at which the transmission allows the prime mover to rotate the at least one wheel.

According to another aspect, a variable speed, self-propelled walk-behind lawnmower includes a housing, a blade housed within the housing for cutting and a handle extending rearwardly from the housing. The handle includes a slidably mounted speed control member movable for adjusting a speed at which a transmission mounted on the housing drives a wheel rotatably mounted to the housing with motive of power from an engine mounted on the housing.

According to a further aspect, a speed control device for a lawnmower includes a handle having a laterally extending grasping bar and a speed control member slidably mounted on the grasping bar for controlling a speed of the lawnmower. The speed control member is slidably mounted on the grasping bar for controlling a speed of the lawnmower. The speed control member is movable axially along the grasping bar between a first zero speed position and a second maximum speed position.

### BRIEF DESCRIPTION OF THE DRAWINGS

FIG. 1 is a partial perspective view of a self-propelled mowing machine having a speed control device thereon in accordance with one embodiment.

FIG. 2 is a partial enlarged view of the handle of the mowing machine of FIG. 1 showing the speed control device mounted thereon.

FIG. 3 is a partial cross-sectional view of the speed control device of FIG. 2 shown with speed control members in respective first, zero speed positions.

FIG. 4 is a partial cross-sectional view similar to FIG. 3 but showing the speed control members in respective second, maximum speed positions.

FIG. 5 is a partial cross-sectional view of one of the speed control members showing a locking device thereof in an unlocked position.

FIG. 6 is a partial cross-sectional view similar to FIG. 5 but showing the locking device in a locked position.

### DETAILED DESCRIPTION

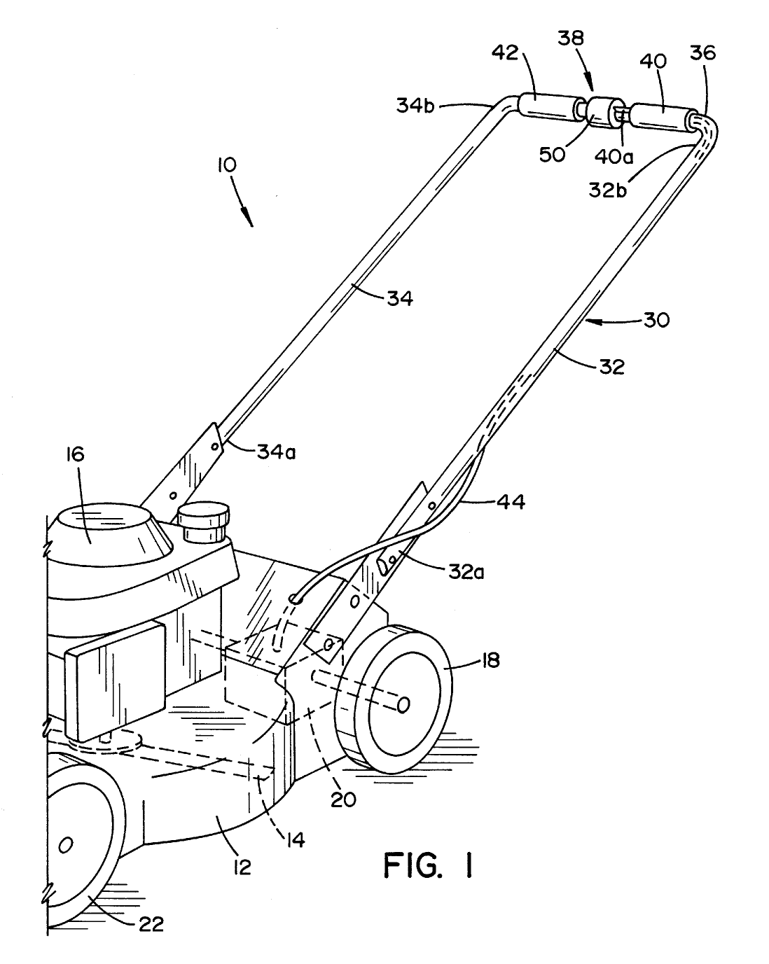

With reference now to the drawings wherein the showings are for purposes of illustrating one or more exemplary embodiments and not for purposes of limiting same, FIG. 1 illustrates a variable speed, self-propelled walk-behind lawnmower generally designated by reference 10. As shown, the lawnmower 10 can include a housing 12, such as the illustrated open-bottomed housing, for rotatably housing a blade 14 for cutting grass. The lawnmower 10 can further include a prime mover 16, which can be an internal combustion engine (as shown in the illustrated embodiment) or some other type of prime mover, mounted on the housing 12 for rotatably driving the blade 14 housed within the housing 12 for cutting (e.g., for cutting grass).

The lawnmower 10 can also include at least one wheel 18 rotatably mounted to the housing 12 and operatively connected through a transmission 20 to the prime mover 16 for driving thereof. The transmission 20 can control the speed at which the prime mover 16 rotates the at least one wheel 18. In the illustrated embodiment, the at least one wheel 18 is a rear wheel rotatably disposed rearwardly on the housing 12 (i.e., toward the back of the housing 12). Additional wheels, such as illustrated wheel 22, can be rotatably mounted to the housing 12 and any number of these additional wheels can be provided as idle wheels (i.e., not connected to the prime mover 16 for power movement thereof). In one embodiment, the transmission 20 is a variable speed transmission, which can adjustably control the speed of the at least one wheel 18 driven by the prime mover 16.

As shown, the lawnmower 10 can additionally include an operating handle 30 extending rearwardly from the housing 12. In the illustrated embodiment, the operating handle 30 extends obliquely from the housing 12. The operating handle 30 includes at least one leg (e.g., legs 32, 34) extending from the housing 12 and a grasping portion or bar 36 supported by the at least one leg in spaced relation relative to the housing 12. As shown, the operating handle 30 of the illustrated embodiment has an inverted U-shape with the at least one leg including first and second legs 32, 34 and the grasping portion 36 extending laterally between the first and second legs 32, 34, particularly at distal ends relative to the housing 12. More specifically, the illustrated operating handle 30 includes at least one leg member 32 having a first end 32a pivotally connected to the housing 12 and a second end 32b spaced apart from the housing 12 and likewise includes a second leg 34 having a first end 34a pivotally connected to the housing 12 and a second end 34b spaced apart from the housing 12. As shown, the grasping portion 36 extends in perpendicular relation to the legs 32, 34 between second ends 32b, 34b of the legs 32, 34 and thus extends laterally relative to the legs 32, 34 and the housing 12. As will be understood and appreciated by those skilled in the art, the operating handle could have some alternate configuration and need not be limited to the type shown in the illustrated embodiment (e.g., the operating handle could include only a single leg).

The lawnmower 10, and particularly the handle 30 thereof, can additionally include a speed control device 38. The speed control device 38 includes a slidably mounted speed control member (e.g., first speed control member 40 and second speed control member 42) that is movable for adjusting a speed at which the transmission 20 mounted on the housing 12 drives the wheel 18 with motive power from the prime mover 16 mounted on the housing 12. In particular, the speed control member is slidably mounted on the grasping portion 36 and operatively connected to the transmission 20 for adjusting the speed at which the transmission 20 allows the prime mover 16 to rotate the at least one wheel 18. In the illustrated embodiment, the speed control member is first speed control member 40 and the handle 30, and particularly the speed control device 38 thereon, includes second speed control member 42.

As shown, both the first and second speed control members 40, 42 of the illustrated embodiment are slidably mounted on the grasping portion 36. Accordingly, the speed control members 40, 42 are slidably moveable along or in parallel with an axis of the grasping portion 36. The speed control members 40, 42 are operatively connected to the transmission 20 through a sheathed cable 44 extending along the leg 32 of the handle 30. In particular, the cable 44 transmits sliding movement of the speed control members 40, 42 to the transmission 20 mechanically for adjusting the variable speed at which the transmission 20 allows the prime mover 16 to rotate the wheel 18, as will be understood and appreciated by those skilled in the art. While the illustrated embodiment is shown with two speed control members 40, 42, it should be understood and appreciated by those skilled in the art that only a single speed control member could be provided. As will be described in more detail below, the first and second speed control members 40, 42 are moved toward one another to increase the speed at which the transmission 20 allows the prime mover 16 to rotate the at least one wheel 18 and are moved apart from one another to decrease the speed at which the transmission 20 allows the prime mover 16 to rotate the at least one wheel 18.

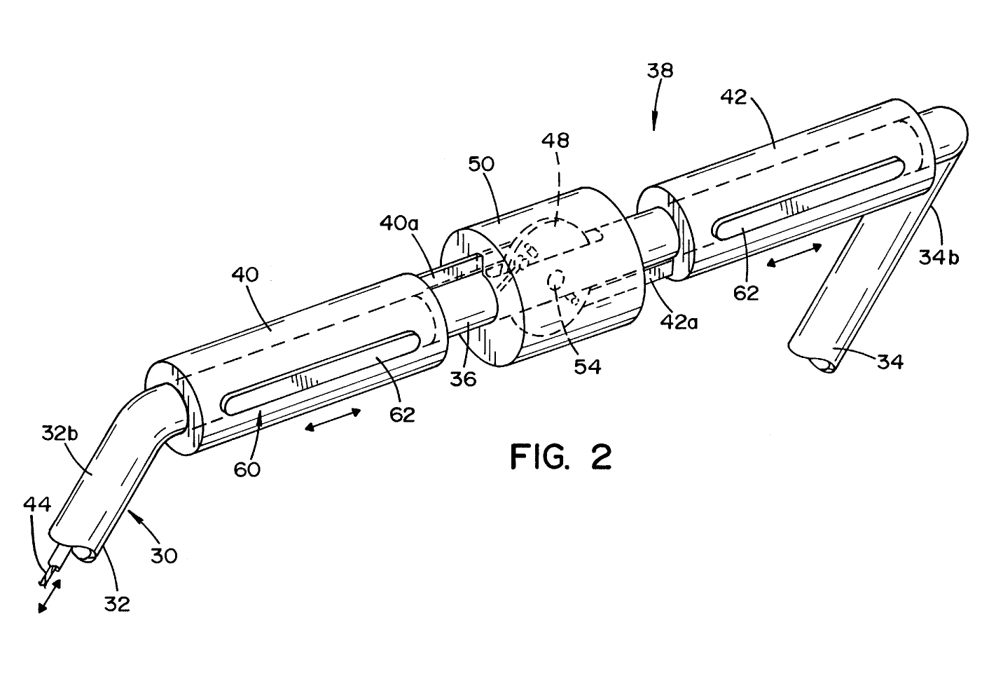

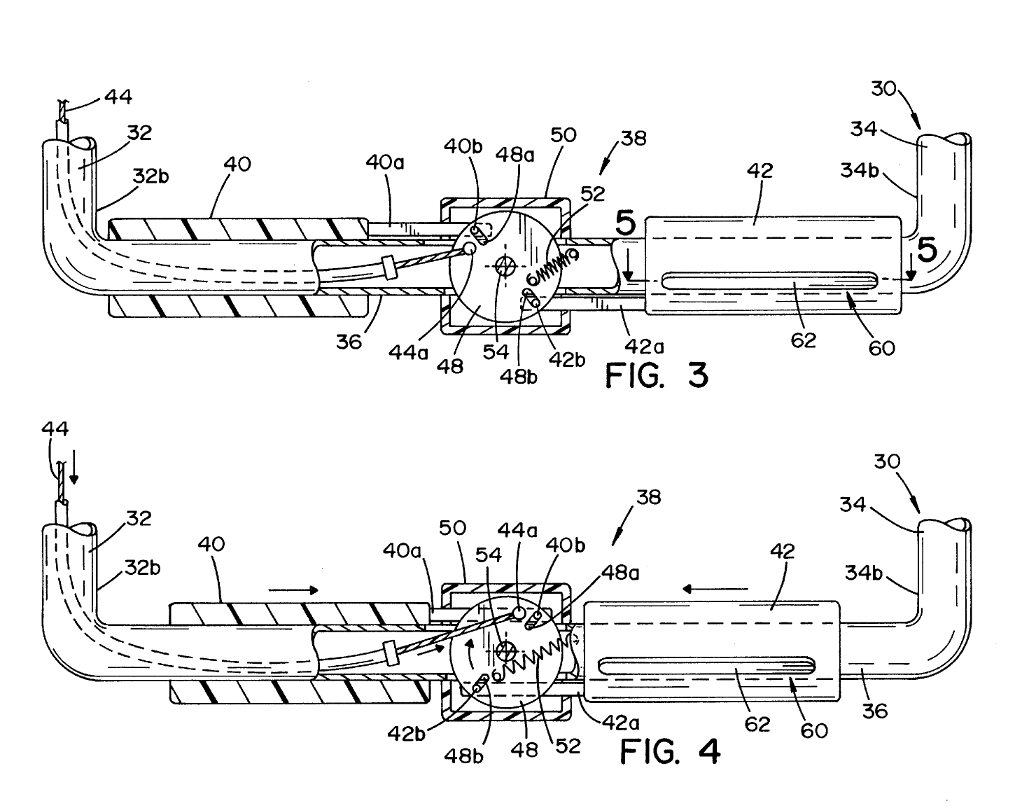

In particular, and with additional reference to FIGS. 2-4, each of the speed control members 40, 42 are movable axially along the grasping portion 36 between respective first, zero speed positions (shown in FIGS. 2 and 3) and second, maximum speed positions (shown in FIG. 4). Thus, the first and second speed control members 40, 42 are moved toward one another when one or both of the speed control members 40, 42 are moved to respective second, maximum speed positions and are moved apart from one another when one or both of the speed control members 40, 42 are moved to respective first, zero speed positions. More particularly, the first and second speed control members 40, 42 are movable from respective first, zero speed positions, also referred to herein as initial positions corresponding to a zero speed of the transmission 20, toward one another for increasing the speed at which the transmission 20 allows the prime mover 16 to drive the at least one wheel 18.

As shown in the illustrated embodiment, the first and second speed control members 40, 42 can be operatively connected to one another and to the sheathed cable 44 through a wheel 48 rotatably mounted between the first and second speed control members 40, 42 on the grasping portion 36. As shown, the wheel 48 can be rotatably mounted to the grasping portion 36 via a shaft or shaft member 54. Accordingly, in the illustrated embodiment, the first and second speed control members 40, 42 are movably connected to one another for corresponding movement through the wheel 48 that is rotatably mounted on the grasping portion 36 such that movement of one of the first and second speed control members 40, 42 is translated to and thereby causes corresponding movement of the other of the first and second speed control members 40, 42.

Particular to the illustrated embodiment, the first and second speed control members 40, 42 include respective rods or rod portions 40a, 42a having distal ends rotatably connected to apertures 48a, 48b defined in the wheel 48 via protruding portions 40b, 42b. Accordingly, for example, movement of the first speed control member 40 axially toward the second speed control member 42 is translated to the wheel 48 via the rod 40a and protruding portion 40b thereby rotating the wheel 48 (clockwise in FIGS. 3 and 4). This rotation of the wheel 48, in turn, axially moves the second speed control member 42 toward the first speed control member 40 via the connection between the wheel 48 and the second speed control member 42 formed by the rod 42a and protruding portion 42b. As shown, a distal end 44a of the cable 44 can be connected to the wheel 48 such that rotation of the wheel 48 corresponding to sliding movement of the control members 40, 42 is translated to the transmission 20. The wheel 48 can be rotatably secured to the grasping portion 36 within a wheel housing 50 that is flanked by the speed control members 40, 42. Thus, the wheel 48 rotatably mounted on the grasping portion 36 translates movement of one or both of the first and second speed control members 40, 42 to the other of the speed control members 40, 42 and to the transmission 20.

In one embodiment, the first and second speed control members 40, 42 are urged toward the initial or first zero speed positions (FIG. 3) and away from one another. Such urging can be provided by the transmission 20 acting through the cable 44 and wheel 48. Alternatively, or in addition, a spring 52 can be operatively connected to the wheel 48 and disposed within the wheel housing 50. In any case, the first and second speed control members 40, 42 can be urged toward their initial positions corresponding to a zero speed state of the transmission 20 and are movable against such urging by an operator of the lawnmower 10 toward one another and away from the respective initial positions for increasing the speed at which the transmission 20 allows the prime mover 16 to rotate the at least one wheel 18. This urging of the speed control members 40, 42 can be used to provide operator presence control. For example, when an operator releases the handle 30, the speed control members 40, 42 are moved via this urging back to initial, zero speed positions.

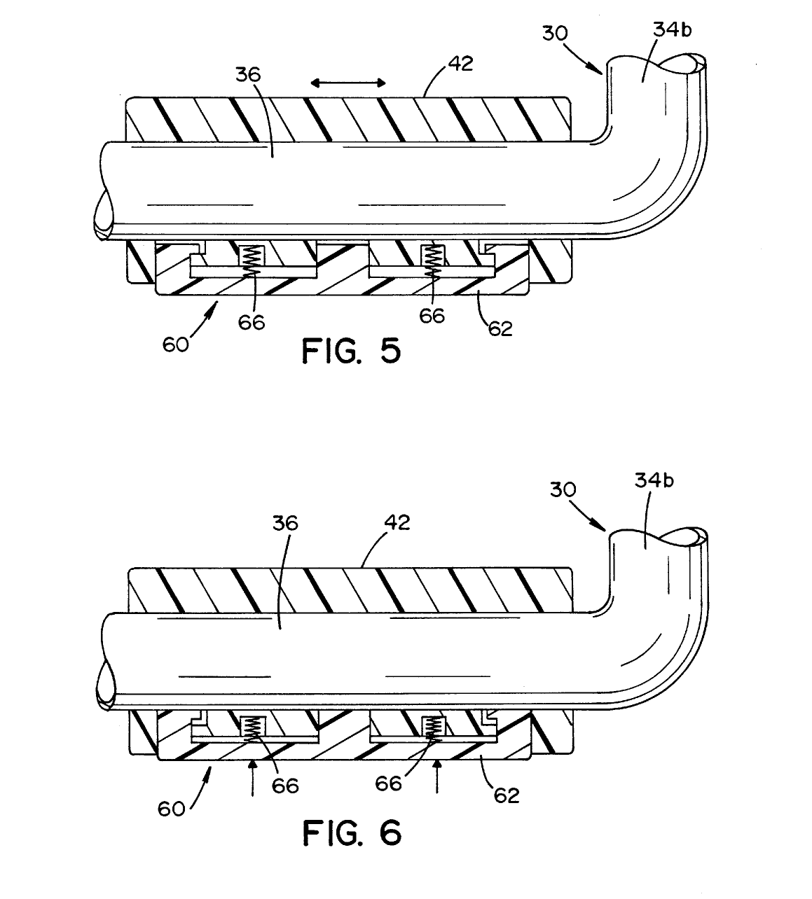

With additional reference to FIGS. 5 and 6, the lawnmower 10 can further include a locking assembly or mechanism 60 that locks one or both of the speed control members 40, 42 in a desired position when the speed control member 40 or 42 is gripped. In the illustrated embodiment, the locking assembly 60, and particularly each speed control member 40, 42, includes a locking mechanism 62 for locking the first and second speed control members 40, 42 in desired positions. The locking mechanism 62 of the illustrated embodiment is a locking actuator slidably disposed on the speed control member 42 for radial movement relative to the grasping portion 36 of the handle 30. The locking actuator 62 is moved radially into the grasping portion 36 of the handle 30 for frictional locking engagement therewith when the speed control member 42 is grasped tightly (e.g., by a user of the lawnmower 10) and moved radially outwardly away from the grasping portion 36 of the handle 30 when the grasping of the speed control member 42 is reduced or released.

As shown, one or more springs 66 can be provided for urging the locking actuator 62 away from the grasping portion 36 of the handle. Thus, the locking actuator 62 moves radially inward into the grasping portion 36 when the speed control member 42 is gripped tightly (as shown in FIG. 6) to lock the sliding position of the speed control member 42 and moves radially outwardly away from the grasping portion 36 (as shown in FIG. 5) when gripping the speed control member 42 is released or reduced. Though the illustrated embodiment shows both the first and second speed control members 40, 42 including the locking actuators 62, it is to be appreciated and understood by those skilled in the art that a single locking actuator could be provided on only one of the first and second speed control members 40, 42, particularly since the speed control members 40, 42 are interconnected for translating relative movement with one another. In operation, the locking assembly 60 locks the first and second speed control members 40, 42 in desired positions corresponding to a desired speed for the lawnmower 10 when one or both of the first and second speed control members 40, 42 are firmly grasped.

Advantageously, the disclosed speed control device 38 greatly relieves hand and/or thumb fatigue during use of the lawnmower 10. In particular, the speed control device 38 disclosed herein has improved user ergonomics, particularly due to the elimination of the requirement for thumb operation to adjust lawnmower speed. In operation, a user can loosen both of his or her hands on the speed control members 40, 42 and slide the speed control members 40, 42 toward one another to begin powered movement of the lawnmower 10 and to speed up powered movement of the lawnmower 10. Once the operator is satisfied with the speed of the lawnmower 10, the operator can grip the speed control members 40, 42 with force to engage the locking actuators 62 into the grasping portion 36 to lock the sliding position of the first and second speed control members 40, 42 and thus the desired speed for the lawnmower 10. If the operator's hands leave the sliding members 40, 42, the locking actuators 62 will unlock the position of the sliding members 40, 42 and due to the urging of the sliding members 40, 42 toward the zero speed control positions, the sliding members 40, 42 will move apart from one another to the respective zero speed conditions. Alternatively, in operation, the user can loosen both hands on the sliding members 40, 42 to unlock the locking actuators 62 and then adjust the speed of the lawnmower 10 (e.g., the user could slow down the lawnmower 10).

Advantageously, the operator can use a single hand to adjust the speed of the lawnmower 10 from either of the speed control members 40, 42 as movement of one speed control member 40 or 42 is translated to the other speed control member 40 or 42. Additionally, with locking actuators 62 provided respectively on both speed control members 40, 42, the operator need only grip one of the speed control members 40, 42 to effect radial movement of the locking actuators 62, which provides flexibility of the other hand while mowing. Also, as shown in the illustrated embodiment, the locking actuators 62 are provided along nearly an entire axial extent of the respective speed control members 40, 42. This allows the operator to put his or her hand anywhere on the speed control member 40 or 42 to operate the associated locking actuator 62.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A lawn mower, comprising:
an open-bottomed housing for rotatably housing a blade for cutting grass;
a prime mover mounted on the housing for rotatably driving the blade;
at least one wheel rotatably mounted to the housing and operatively connected through a transmission to the prime mover for driving thereof, the transmission controlling the speed at which the prime mover rotates the at least one wheel;
an operating handle extending rearwardly from the housing, the operating handle including at least one leg extending from the housing and a grasping portion supported by the at least one leg in spaced relation relative to the housing; and
a speed control device including a speed control member slidably mounted on the grasping portion and operatively connected to the transmission for adjusting the speed at which the transmission allows the prime mover to rotate the at least one wheel.

2. The lawn mower of claim 1 wherein the handle is an inverted U-shape with the at least one leg including first and second legs and the grasping portion extending between the first and second legs.

3. The lawn mower of claim 1 wherein the speed control member is operatively connected to the transmission though a cable extending along the at least one leg of the handle, sliding movement of the speed control member transmitted to the transmission mechanically through the cable.

4. The lawn mower of claim 1 wherein the speed control member is a first speed control member and the speed control device includes a second speed control member slidably mounted on the grasping portion and operatively connected to the transmission for adjusting the speed at which the transmission allows the prime mover to rotate the at least one wheel, the first and second speed control members moved toward one another to increase the speed at which the transmission allows the prime mover to rotate the at least one wheel and moved apart from one another to decrease the speed at which the transmission allows the prime mover to rotate the at least one wheel.

5. The lawn mower of claim 4 wherein the first and second speed control members are operatively connected to one another and to a cable connected to the transmission through a wheel rotatably mounted between the first and second speed control members on the handle portion.

6. The lawn mower of claim 4 wherein the first and second control members are urged toward initial positions corresponding to a zero speed state of the transmission and are movable toward one another and away from respective initial positions for increasing the speed at which the transmission allows the prime mover to rotate the at least one wheel.

7. The lawn mower of claim 4 wherein each of the first and second speed control members includes a locking mechanism for locking first and second speed control members in desired positions, the locking mechanism of each of the first and second speed control members moved to a locked state by gripping of the first and second speed control members and moved to an unlocked state by releasing gripping of the first and second speed control members.

8. The lawn mower of claim 1 wherein the speed control device further includes a locking mechanism for selectively locking the speed control member in a desired position, the locking mechanism is a locking actuator slidably disposed on the speed control member for radial movement relative the grasping portion of the handle, the locking actuator moved radially into the grasping portion of the handle for frictional locking engagement therewith when the speed control member is grasped tightly and moved radially outwardly away from the grasping portion of the handle when grasping of the speed control member is reduced.

9. The lawn mower of claim 8 wherein the locking mechanism includes at least one spring urging the locking actuator away from the grasping portion of the handle.

10. A variable speed, self-propelled walk-behind lawnmower, comprising:
a housing;
a blade housed within the housing for cutting;
a handle extending rearwardly from the housing, the handle including a slidably mounted speed control member movable for adjusting a speed at which a transmission mounted on the housing drives a wheel rotatably mounted to the housing with motive power from an engine mounted on the housing.

11. The walk-behind mower of claim 10 wherein the handle includes at least one leg member having a first end pivotally connected to the housing and a second end spaced apart from the housing, and a grasping portion extending in perpendicular relation to the at least one leg at the second end of the at least one leg, the speed control member slidably movable along or in parallel with an axis of the grasping portion.

12. The walk-behind mower of claim 11 wherein the speed control member is connected to the transmission through a sheathed cable.

13. The walk-behind mower of claim 10 wherein the speed control member is a first speed control member and the handle includes a second speed control member, the first and second speed control members slidably mounted on a laterally extending grasping portion of the handle.

14. The walk-behind mower of claim 13 wherein the first and second speed control members are movable from an initial position corresponding to a zero speed of the transmission toward one another for increasing speed at which the transmission allows the engine to drive the wheel.

15. The walk-behind mower of claim 14 wherein the first and second speed control members are urged toward the initial positions and away from one another.

16. The walk-behind mower of claim 14 wherein the first and second speed control members are movably connected to one another for corresponding movement through a wheel rotatably mounted on the grasping portion such that movement of one of the first and second speed control members causes corresponding movement of the other of the first and second speed control members.

17. The walk-behind mower of claim 10 further including a locking assembly that locks the speed control member in a desired position when the speed control member is gripped.

18. The walk-behind mower of claim 17 wherein the locking assembly includes a lock actuator that moves radially inward into the grasping portion when the speed control member is gripped tightly to lock the sliding position of the speed control member and moves radially outward away from the grasping portion when gripping of the speed control member is released or reduced.

19. A speed control device for a lawn mower, comprising:
a handle including a laterally extending grasping bar; and
a speed control member slidably mounted on the grasping bar for controlling a speed of the lawn mower, the speed control member movable axially along the grasping bar between a first zero speed position and a second maximum speed position.

20. The speed control device of claim 19 wherein the speed control member is a first speed control member and the speed control device further includes:
a second speed control member slidably mounted on the grasping bar, the first and second speed control members moved toward one another when the first speed control member is moved to the second maximum speed position and moved apart from one another when the first speed control member is moved to the first zero speed position;
a wheel rotatably mounted on the grasping bar for translating movement of one of the first and second speed control members to the other of the speed control members; and
a locking mechanism for locking the first and second speed control members in desired positions corresponding to a desired speed when one or both the first and second sped control members are firmly grasped.
